(19) United States
(12) Patent Application Publication
(10) Pub. No.: US 2005/0132582 A1
(43) Pub. Date: Jun. 23, 2005

(54) Jigsaws

(76) Inventor: Peter Gudmundson, Plymouth, MN (US)

Correspondence Address: LEFFERT JAY & POLGLAZE, P.A., P.O. BOX 581009, MINNEAPOLIS, MN, 55458-1009, US

(21) Appl. No.: 10/738,557

(22) Filed: Dec. 17, 2003

(51) Int. Cl. B27B 19/00

(52) U.S. Cl. 30/392

(57) ABSTRACT

Jigsaws and methods are provided. A jigsaw has a blade holder adapted to attach a blade to the jigsaw. The blade holder is located proximate a trailing end of the jigsaw when the jigsaw is in use. A grip is disposed substantially directly above the blade holder and proximate the trailing end.

### TECHNICAL FIELD OF THE INVENTION

The present invention relates generally to saws and in particular the present invention relates to jigsaws.

### BACKGROUND OF THE INVENTION

Many jigsaws are set up so that the user is required to lean over the saw to see where the user is cutting. Further, the grip position for many jigsaws places the user's wrist and arm in an awkward position. Leaning over a jigsaw and awkward positioning of the wrist and arm while cutting with the jigsaw can lead to difficulty in making a proper cut with the jigsaw, and can be dangerous to a user.

For the reasons stated above, and for other reasons stated below which will become apparent to those skilled in the art upon reading and understanding the present specification, there is a need in the art for alternative jigsaws.

### SUMMARY

The above-mentioned problems with jigsaws and other problems are addressed by the present invention and will be understood by reading and studying the following specification.

One embodiment of the invention provides a jigsaw that has a blade holder adapted to attach a blade to the jigsaw. The blade holder is located proximate a trailing end of the jigsaw when the jigsaw is in use. A grip is disposed substantially directly above the blade holder and proximate the trailing end.

Another embodiment provides a method of operating a jigsaw that includes grasping a grip of the jigsaw with one hand, and pushing on the grip to move the jigsaw over a surface of a work piece as a blade of the jigsaw cuts through the work piece. The grip is located proximate a trailing edge of the jigsaw and substantially directly above the blade.

Another embodiment provides a method of storing a jigsaw on a surface. The method includes placing the jigsaw in a storage position so that the jigsaw is tilted from a use position about an edge of a base of the jigsaw and so that a portion of a housing of the jigsaw rests against the surface. The portion of the housing that rests against the surface is opposite a blade holder of the jigsaw and a grip of the jigsaw that is disposed substantially directly above the blade holder.

Further embodiments of the invention include methods and apparatus of varying scope.

### BRIEF DESCRIPTION OF THE DRAWINGS

FIGS. 1 and 2 illustrate operation of a conventional jigsaw.

FIG. 3A illustrates a jigsaw according to an embodiment of the present invention.

FIG. 3B illustrates a user grasping a grip of a jigsaw according to another embodiment of the present invention.

FIG. 4 illustrates an interior of a jigsaw according to another embodiment of the present invention.

FIG. 5 illustrates storing of a jigsaw according to another embodiment of the present invention.

FIG. 6 illustrates a jigsaw according to another embodiment of the present invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

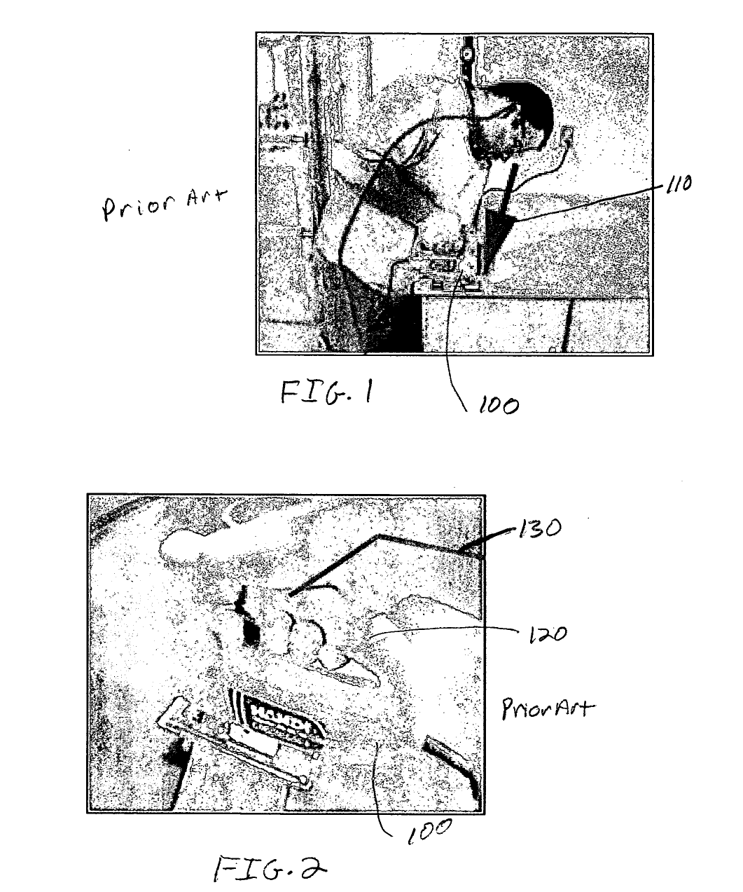

FIGS. 1 and 2 illustrate a conventional jigsaw 100 during operation. FIG. 1 shows that a user is required to bend over jigsaw 100 to see the position of the blade of jigsaw 100 from the front of the jigsaw along a sight line 110 during cutting. FIG. 2 shows that the position of grip 120 of jigsaw 100 places the user's wrist and arm in an awkward position as indicated by a line 130, especially for longer cuts as jigsaw 100 moves further away from the user's body. Moreover, as jigsaw 100 moves further away from the user's body, it is more difficult to see the position of the blade.

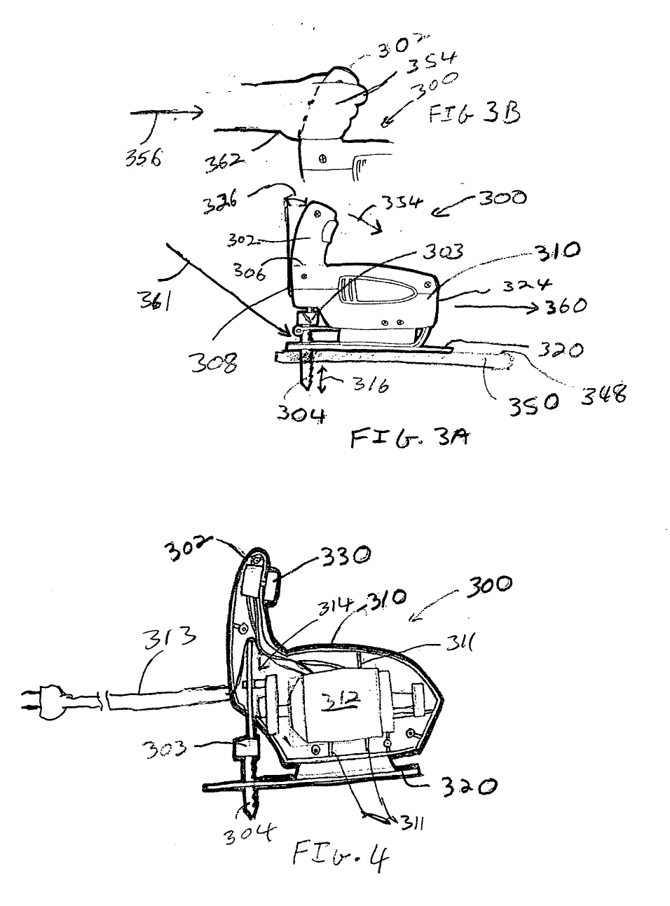

FIGS. 3-5 illustrate a jigsaw 300 according to an embodiment of the present invention. Jigsaw 300 has a grip (or handle) 302 placed above a blade holder 303 adapted to attach a blade 304 to jigsaw 300. Specifically, for one embodiment, a base 306 of grip 302 is disposed directly above blade holder 303, as shown in FIG. 3A. As best seen in FIG. 3A, blade holder 303, blade 304, and grip 302 are located proximate a trailing end 308 of jigsaw 300 when jigsaw 300 is cutting through a work-piece 350.

For one embodiment, blade holder 303 is a collar-like clamp that receives blade 304 therein and clamps blade 304 in place. Blade holders of various types for jigsaws are known in the art and will not be described further here.

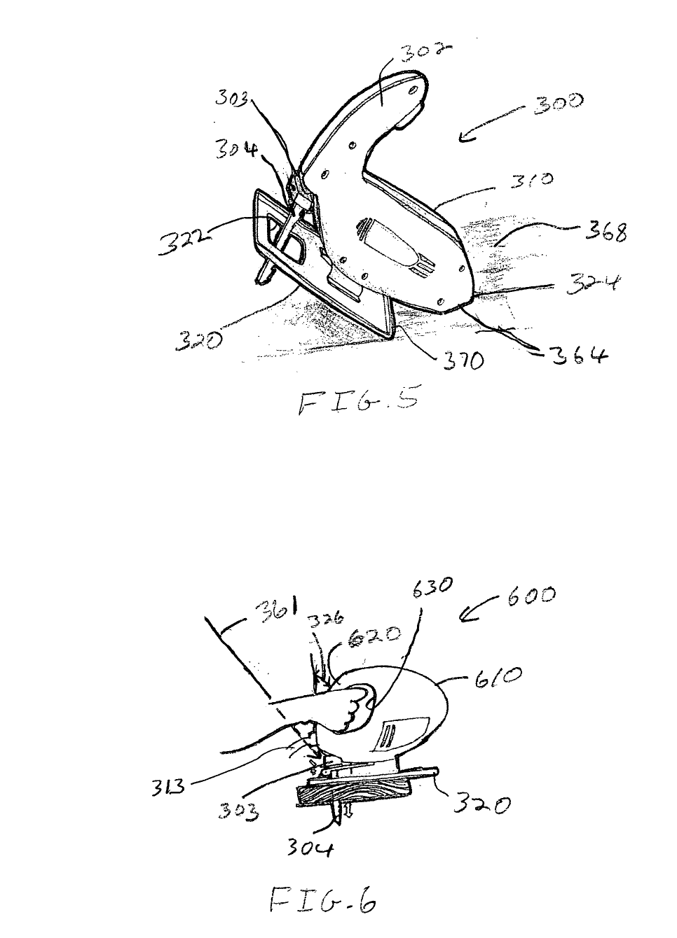

For one embodiment, grip 302 is formed integrally with a housing 310 of jigsaw 300, e.g., by injection molding. Housing 310 contains an electric motor 312 attached thereto, for one embodiment, by supports 311, as shown in FIG. 4. A drive 314 is contained in housing 310 and is coupled between electric motor 312 and blade holder 303, as shown in FIG. 4. Drive 314 is adapted to reciprocate blade holder 303, and thus blade 304, as indicated by arrows 316 of FIG. 3A, in response to operation of electric motor 312. Electric motor 312 is connectable to an electrical receptacle via electrical cord 313, shown in FIG. 4. FIG. 3A further shows that blade holder 303, blade 304, and grip 302 are located behind electric motor 312 when jigsaw 300 is cutting through work-piece 350. It should be understood that a different power supply, such as a rechargeable battery or the like, could be used without departing from the scope of the invention.

Housing 310 can be made from plastic, such as ABS (a class of plastic based on acrylonitrile-butadiene-styrene copolymers) or the like. Housing 310 is attached to a base 320 of jigsaw 300, as shown in FIGS. 3A, 4, and 5. For one embodiment, blade holder 303 is aligned with a hole 322 that passes through base 320 so that blade 302 can extend through hole 322 when installed in blade holder 303, as shown in FIG. 5.

For one embodiment, grip 302 is inclined at an angle 326 from a line that is substantially perpendicular to the base 320 and substantially parallel to blade 304, as shown in FIG. 3A. That is, grip 302 is inclined away from trailing end 308 and blade holder 303 toward motor 312 and a front end 324 opposite trailing end 308. For another embodiment, the angle 326 is about 5 degrees to about 25 degrees. A push-button (or trigger) switch 330 is disposed within grip 302 so as to protrude from an exterior surface of grip 302, as best shown in FIG. 4. Switch 330 is electrically connected to motor 312 for activating motor 312 when a user depresses switch 330 while gripping grip 302. For one embodiment, switch 330 is biased in an extended position corresponding to the motor being in a non-activated state.

In operation, jigsaw 300 is located on a surface 348 of work-piece 350, as shown in FIG. 3A. Specifically, base 320 is placed in contact with the surface 348. A user's hand 354 grasps grip 302, as shown in FIG. 3B, and depresses switch 330 to activate motor 312, which reciprocates blade 304 via drive 314. When the user grasps grip 302 and pushes against grip 302 in the direction of arrow 356 (i.e., substantially parallel to surface 348 and away from the user), the inclination of grip 302 causes a component of force to be exerted on the grip that is directed toward work-piece 350, as indicated by the arrow 358 in FIG. 3A. This force acts to press base 320 against surface 348. Pushing against grip 302 also moves jigsaw 300 in the direction of arrow 360, i.e., substantially parallel to surface 348 and away from the user. This feeds the reciprocating blade 304 into work-piece 350 so that the reciprocating blade 304 can cut through work-piece 350 as base 320 slides over surface 348.

Trailing end 308 is closest to the eyes of the user so the user can view the position of blade 304 directly from behind jigsaw 300 without bending over jigsaw 300, as indicated by sight-line arrow 361 in FIG. 3A, when jigsaw 300 is in its use position. When the user's hand 354 grasps grip 302, the user's wrist 362 is kept substantially straight, and hand 354 is in a natural position when jigsaw 300 is in its use position making a cut, as shown in FIG. 3B. Note that grip 302 is inclined toward the direction of motion of jigsaw 300 while in use. This acts to keep the user's wrist substantially straight and the user's hand in a natural position.

FIG. 5 illustrates storing of jigsaw 300 according to another embodiment of the present invention. The method includes placing jigsaw 300 in a storage position so that jigsaw 300 is tilted from its use position about an edge 370 of base 320 and so that a portion 364 of housing 310 at front end 324 of jigsaw 300 rests against a surface, such as surface 368. This allows jigsaw 300 to stand nearly upright on surface 368, as opposed to having to be laid on its side like conventional jigsaws. Surface 368 can be any surface, e.g., flat, curved, etc., including a work piece surface, such as surface 348 of work piece 350.

FIG. 6 illustrates a jigsaw 600 according to another embodiment of the present invention. Jigsaw 600 is substantially the same as jigsaw 300, except that housing 610 of jigsaw 600 has a closed grip 620, as shown in FIG. 6. Specifically, grip 620 forms a portion of a boundary of a hole 630 that passes though housing 610. The user's hand passes through hole 630 when grasping grip 620. As described above for jigsaw 300, grip 620 can be formed integrally with housing 610, e.g., by injection molding. Elements common to FIGS. 1-5 and FIG. 6 are as described above.

### CONCLUSION

Embodiments of the present invention provide jigsaws. For one embodiment, a jigsaw has a blade holder adapted to attach a blade to the jigsaw. The blade holder is located proximate a trailing end of the jigsaw when the jigsaw is in use. A grip is located directly above the blade holder and proximate the trailing end. For another embodiment, the grip is tilted away from the trailing end toward the direction that the jigsaw moves while cutting. The advantages of the present invention over standard jigsaws include by way of example an improved and more natural gripping position for the jigsaw, improved sight lines for cutting, improved safety due to improved sight lines, and a better control of cutting due to improved sight lines and gripping position.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. A jigsaw comprising:
a blade holder adapted to attach a blade to the jigsaw, the blade holder located proximate a trailing end of the jigsaw when the jigsaw is in use;
a grip disposed substantially directly above the blade holder and proximate the trailing end.

2. The jigsaw of claim 1, wherein the grip and the blade holder are located behind a motor of the jigsaw when the jigsaw is in use.

3. The jigsaw of claim 1, wherein the grip is inclined away the trailing end toward an opposite end of the jigsaw.

4. The jigsaw of claim 1, wherein the grip is a closed grip.

5. The jigsaw of claim 1, wherein the grip is integral with a housing of the jigsaw.

6. The jigsaw of claim 1, and further comprising a push-button switch disposed within the grip and protruding from an exterior surface of the grip.

7. The jigsaw of claim 1, wherein the grip is adapted to act to keep a wrist of a user substantially straight while a hand of the user attached to the wrist grasps the grip when the jigsaw is in use.

8. A jigsaw comprising:
a base;
a housing attached to the base;
a motor located within the housing;
a blade holder coupled to the motor, the blade holder located proximate a trailing end of the jigsaw when the jigsaw is in use, the blade holder adapted to attach a blade to the jigsaw; and
a grip disposed substantially directly above the blade holder and proximate the trailing end, the grip inclined away from the trailing end toward the motor.

9. The jigsaw of claim 8, wherein the grip forms a portion of a boundary of a hole that passes though the housing.

10. The jigsaw of claim 8, wherein the grip is integral with the housing.

11. The jigsaw of claim 8, and further comprising a push-button switch disposed within the grip and protruding from an exterior surface of the grip, the push-button switch electrically coupled to the motor for activating the motor.

12. The jigsaw of claim 8, wherein a drive couples the blade holder to the motor, the drive adapted to reciprocate the blade holder and thus the blade in response to operation of the motor.

13. The jigsaw of claim 8, wherein the inclination of the grip acts to keep a wrist of a user substantially straight while a hand of the user attached to the wrist grasps the grip when the jigsaw is in use.

14. A method of operating a jigsaw, comprising:
grasping a grip of the jigsaw with one hand; and
pushing on the grip to move the jigsaw over a surface of a work piece as a blade of the jigsaw cuts through the work piece, the grip located proximate a trailing end of the jigsaw and substantially directly above the blade.

15. The method of claim 14, wherein grasping the grip acts to keep a user's wrist connected to the one hand substantially straight.

16. The method of claim 14, wherein the grip is inclined away from the trailing edge toward a direction of motion of the jigsaw.

17. The method of claim 14, and further comprising viewing the position of blade directly from behind jigsaw.

18. The method of claim 14, wherein grasping and pushing on the grip acts to press the jigsaw against the work piece.

19. The method of claim 14, and further comprising depressing a push-button switch with the one hand while grasping the grip to activate the blade.

20. The method of claim 14, wherein grasping the grip further comprises passing the one hand through a hole in a housing of the jigsaw.

21. A method of operating a jigsaw, comprising:
grasping a grip of the jigsaw with one hand;
pushing on the grip to move the jigsaw over a surface of a work piece as a blade of the jigsaw cuts through the work piece, the grip located proximate a trailing end of the jigsaw and substantially directly above the blade, the grip further inclined away from the trailing end toward a direction of motion of the jigsaw; and
viewing the position of blade directly from behind jigsaw;
wherein grasping the grip acts to keep a user's wrist connected to the one hand substantially straight while the jigsaw moves over the surface of the work piece.

22. The method of claim 21, wherein grasping and pushing on the grip acts to press the jigsaw against the work piece.

23. The method of claim 21, and further comprising depressing a push-button switch with the one hand while grasping the grip to activate the blade.

24. The method of claim 21, wherein grasping the grip further comprises passing the one hand through a hole in a housing of the jigsaw.

25. A method of storing a jigsaw on a surface, comprising:
placing the jigsaw in a storage position so that the jigsaw is tilted from a use position about an edge of a base of the jigsaw and so that a portion of a housing of the jigsaw rests against the surface, wherein the portion of the housing that rests against the surface is opposite a blade holder of the jigsaw and a grip of the jigsaw that is disposed directly above the blade holder.

26. The method of claim 25, wherein in the storage position, the jigsaw does not lay on a side thereof.
